(19) United States
(12) Patent Application Publication
(10) Pub. No.: US 2014/0184999 A1
(43) Pub. Date: Jul. 3, 2014

(54) SPATIAL LIGHT MODULATOR COMPRISING A LIQUID CRYSTAL DEVICE HAVING REDUCED STRAY LIGHT

(71) Applicants: Bo Kroll, London (GB); Norbert Leister, Dresden (DE)

(72) Inventors: Bo Kroll, London (GB); Norbert Leister, Dresden (DE)

(73) Assignee: SEEREAL TECHNOLOGIES S.A., Munsbach (LU)

(21) Appl. No.: 14/238,571

(22) PCT Filed: Aug. 10, 2012
(86) PCT No.: PCT/EP2012/065686

§ 371 Date: Feb. 12, 2014

(30) Foreign Application Priority Data
Aug. 12, 2011 (DE) 10 2011 052 626.9

(51) Int. Cl. G02F 1/1343; G03H 1/22

(52) U.S. Cl. CPC G02F 1/134363; G03H 1/2294
USPC 349/139; 359/9

(57) ABSTRACT

A liquid-crystal device having at least one first electrode arranged in a first plane, and a plurality of second electrodes arranged in a second plane essentially parallel to the first plane, a liquid-crystal layer arranged between the first plane and the second plane, which liquid-crystal layer is formed to modify a property of light passing through the liquid-crystal layer, as a function of the level of an electrical voltage applied between one first electrode and one second electrode. The liquid-crystal device has electrodes formed and arranged in such that a transverse electric field can be generated in an intermediate region between neighboring second electrodes, which orientates the liquid crystals contained in the intermediate region to cause, directly an amplitude reduction of light passing through the intermediate region of the liquid-crystal device, which is greater than an amplitude reduction of the light passing through the liquid-crystal layer outside the intermediate region.

The invention relates to a liquid-crystal device having at least one first electrode, which is arranged in a first plane, and having a plurality of second electrodes, which are arranged in a second plane essentially parallel to the first plane, a liquid-crystal layer being arranged between the first plane and the second plane, which liquid-crystal layer is formed in order to modify a property, in particular the phase and/or the polarization, of light passing through the liquid-crystal layer, as a function of the level of an electrical voltage applied between the at least one first electrode and at least one second electrode.

Liquid-crystal devices of this type are used inter alia in holographic displays, for example as part of an optical light modulator. Such an arrangement is known, for example, from WO 2010/149587 A2. This document describes a light modulation apparatus for a display for the representation of two- and/or three-dimensional image contents or image sequences. The light modulation apparatus comprises a light modulator and a control device for controlling the light modulator. The phase and/or the amplitude of an essentially collimated light wave field can be modified by the light modulator as a function of the position of the light modulator. In the propagation direction of the light wave field, at least one diffraction device which has a variable diffraction structure is arranged after the light modulator. With the diffraction structure, the light wave field modified by the light modulator can be diffracted variably in a predeterminable way.

In such an apparatus, perturbations can occur due to light which passes through the regions between neighboring second electrodes and which has different properties, in particular a different phase, than the light which passes through the central region of the second electrodes. Inter alia, deviation from the desired modulation or scattering of light at the edges of the electrodes may disadvantageously take place. It is also possible for the light passing through the regions between neighboring second electrodes to have a perturbing and undesired phase shift. These phenomena result in perturbed image representation.

In WO 2009/156191 A1, it is therefore proposed to use an apodization mask, which is modified in such a way that it reduces the intensities of selected higher diffraction orders and/or stray light emerging from the light modulator. In particular, it is proposed to use an array of apodization masks in a direct view holographic display, which comprises a controllable light modulator having modulator cells which modulates incident coherent light in phase and/or amplitude. For a predetermined group of modulator cells, the apodization masks have the same apodization function, with which a complex amplitude transparency can be adjusted for the modulator cells, which corresponds to an individually predefined intensity profile in the far field of the light modulator, the predetermined intensity profile including a reduction of the light

[symbol]

In order to determine the apodization function, an iterative method is provided, which is carried out as a computation routine in a computation unit. The field of application is light modulation devices for the production of various modulation types in direct view holographic displays. This solution, however, is elaborate and expensive since a large number of additional components are required.

It is therefore an object of the present invention to provide a more simply and more economically producible liquid-crystal device, in which the described perturbing effects are substantially avoided.

The object is achieved by a liquid-crystal device which is characterized in that the second electrodes are formed and arranged in such a way that a transverse electric field can be generated in an intermediate region between neighboring second electrodes, which orientates the liquid crystals contained in the intermediate region in such a way, particularly in cooperation with further components of the liquid-crystal device, for example one or more polarization filters, as to cause, directly or indirectly, an amplitude reduction of light passing through the intermediate region of the liquid-crystal device, which is greater than an amplitude reduction of the light passing through the liquid-crystal layer outside the intermediate region. As a function of the composition of the first and/or second electrodes, light which passes through the liquid-crystal layer outside the intermediate region can naturally experience almost no amplitude reduction, i.e. the amplitude reduction has a value of almost zero. In this case, there is an amplitude reduction of the light passing through the intermediate region of the liquid-crystal device when the amplitude reduction relative to the light entering the liquid-crystal device has a non-zero value.

According to the invention, it has been discovered that the perturbing effects, which are attributable to the light passing through the intermediate regions between the second electrodes—and/or, if there are a plurality of first electrodes, the light passing through the intermediate regions between the first electrodes—can be avoided by particular formation and arrangement of the electrodes themselves. This is by virtue of the fact that some liquid crystals themselves, namely those which are contained in the intermediate region between the electrodes—optionally in cooperation with further components—fulfill the function of an attenuator. To this extent, additional masks, which block or attenuate the light passing through the intermediate regions, can be substantially obviated in an advantageous manner.

The at least one first electrode and the second electrodes are preferably made of a material which is transparent for the light interacting with the liquid-crystal device, while reflecting and/or absorbing as little light as possible. In the context of the present invention, liquid crystals which [symbol] crystals of the liquid-crystal layer which lie in the immediate vicinity of an intermediate region between neighboring second electrodes (and if applicable between multiple neighboring first electrodes). The intermediate region can thus be understood as a spatial region or volume which extends from the intermediate region as a base surface perpendicularly from the surface of the electrodes, or from the surface of the substrate on which the electrode(s) is/are arranged, into the liquid-crystal layer.

In a particularly advantageous embodiment of a liquid-crystal device, this effect is achieved in that the distance between neighboring second electrodes is small enough that, in the intermediate region, it is possible to generate a transverse electric field which orientates the liquid crystals contained in the intermediate region in such a way, as to cause, directly or indirectly, an amplitude reduction of light passing through the intermediate region of the liquid-crystal device, which is greater than an amplitude reduction of the light passing through the liquid-crystal layer outside the intermediate region.

In a particular embodiment, an amplitude reduction of light passing through the intermediate region of the liquid-crystal device by 50%, in particular by 75%, more particularly by 90%, is achieved.

In a particular embodiment of a liquid-crystal device, there is a single first electrode in the first plane. In another embodiment, a plurality of first electrodes are arranged in the first plane.

In a liquid-crystal device which comprises a plurality of first electrodes in the first plane, the first electrodes may—similarly as in relation to the second electrodes—advantageously be formed and arranged in such a way that, in an intermediate region between neighboring first electrodes, it is possible to generate a transverse electric field which orientates the liquid crystals contained in the intermediate region in such a way, particularly in cooperation with further components of the liquid-crystal device, for example one or more polarization filters, as to cause, directly or indirectly, an amplitude reduction of light passing through the intermediate region of the liquid-crystal device, which is greater than an amplitude reduction of the light passing through the liquid-crystal layer outside the intermediate region.

In a very particularly advantageous embodiment, liquid crystals of the liquid-crystal layer can be orientated, as a function of the level of an electrical voltage applied between the at least one first electrode and the second electrodes, in a first orientation (relative to the molecular axis of the liquid crystals) or in a second orientation (relative to the molecular axis of the liquid crystals), in particular perpendicular to the first, or in intermediate settings between the first orientation and the second orientation. In particular, the light passing through the liquid-crystal layer may have a phase dependent on the electrical voltage.

An amplitude reduction of the light passing through the intermediate region of the liquid-crystal device can, in particular, be achieved in an embodiment wherein, in the intermediate region between a plurality of neighboring first electrodes and/or in the intermediate region between neighboring second electrodes, it is possible to generate a transverse electric field which leads to a third orientation, different than the first orientation and the second orientation and intermediate settings between the first orientation and the second orientation, of the liquid crystals contained in the intermediate region.

The direction of the third orientation may for example—depending on the constraints of the use of the liquid-crystal device and depending on the type of liquid crystals—be orientated perpendicularly to the first and/or second plane. In some applications, however, it is advantageous for the direction of the third orientation to be orientated approximately parallel to the first and/or second plane, which may also be referred to as in-plane orientation.

The orientations will be explained with reference to an ECB LC mode (ECB=Electrically Controlled Birefringence). In this, a first orientation is achieved by surface orientation of the LC molecules, in that the longitudinal axes of the LC molecules are orientated approximately parallel to the first and second planes. The expression “approximately parallel to the first and second planes” in this context means that the magnitude of the angle between the longitudinal axis of the LC molecules and the first and/or second plane does not exceed a value of 5 degrees.

In this example, the first orientation furthermore has an angle of more than 30 degrees, preferably between 45 and 90 degrees, relative to the connecting line between two first electrodes and/or between two second electrodes.

The second orientation, which is brought about by applying an electric field between a first electrode and an opposing second electrode, is arranged perpendicularly to the first and second planes. The third orientation, which is brought about by a transverse field between neighboring first electrodes and/or neighboring second electrodes, is approximately parallel to the first and second planes but rotated relative to the first orientation. In the preferred embodiment, the rotation angle between the first and third orientations is 45 degrees. As additional elements, the device preferably respectively comprises a linear polarizer on the input side and on the output side. The transmission directions of the two linear polarizers are arranged mutually parallel and parallel to the first orientation. In this case, the first and second orientations, as well as intermediate settings between these two orientations, thus approximately have the same transmission but a different phase retardation. The third orientation, however, has a lower transmission than the first and second orientations.

In an advantageous embodiment, the direction of the first orientation and the direction of the

[symbol]

In particular, in such an embodiment, the direction of the third orientation may advantageously be orientated perpendicularly to the first orientation and/or perpendicularly to the second orientation and/or perpendicularly to the direction of at least one of the intermediate settings.

Advantageously, the liquid-crystal device may be formed in such a way that the direction of the first orientation and/or the direction of the second orientation are respectively arranged approximately parallel to the first and second planes (in-plane), while the direction of the third orientation is arranged at a non-zero angle, in particular perpendicularly, to the first and/or second plane.

An example of the two aforementioned approaches will be described with reference to the PSS LC mode (PSS=Polarization-Shielded Smectic). For a device which has circular polarizers as further elements on the input side and on the output side, the phase modulation for the PSS LC mode is carried out by an in-plane rotation of the LC molecules, so that both the first orientation and the second orientation are arranged approximately parallel to the first and second planes. The PSS LC mode uses special LC molecules which orientate perpendicularly to an electric field. The in-plane rotation from the first orientation to the second orientation is thus carried out by an electric field between a first electrode and a second electrode.

A reduction in the transmission is carried out by rotation of the LC molecules into an orientation which is no longer parallel to the first and second planes. This rotation is carried out by a transverse field between neighboring first electrodes and/or neighboring second electrodes. A minimum transmission would be achieved for a third orientation perpendicular to the first and second planes, that is to say also perpendicular to the first and second orientations.

It is, however, possible for the direction of the third orientation to be arranged parallel to the first and second planes (i.e. in-plane). For example, this is the case in an ECB LC mode, as already described above.

In an advantageous embodiment, in order to induce the transverse field, an electrical voltage no higher than that conventionally necessary for operating the liquid-crystal device—irrespective of avoidance of perturbing effects due to the light passing through intermediate regions—is applied between the electrodes. This has the advantage that the physical effects, for example a pixel-dependent phase modulation of the light, which are intended to be caused by the liquid-crystal device, are not impaired.

To this extent, a maximum electrical voltage may advantageously be defined, at which the liquid crystals arranged outside the intermediate region are orientated either in the first or in the second orientation. As an alternative or in addition, a maximum electrical voltage may advantageously be defined, at which, in relation to light which passes through the liquid-crystal layer outside the intermediate region, a relative phase retardation of 2 pi can be induced between the first and second orientations.

It is advantageous—as an alternative or in addition—for a voltage range to be defined, in which a lower voltage range limit is assigned to a minimum phase retardation of the light passing through the liquid-crystal layer outside the intermediate region and in which an upper voltage range limit is assigned to a maximum phase retardation of the light passing through the liquid-crystal layer outside the intermediate region, or, vice versa, in which a lower voltage range limit is assigned to a maximum phase retardation of the light passing through the liquid-crystal layer outside the intermediate region and in which an upper voltage range limit is assigned to a minimum phase retardation of the light passing through the liquid-crystal layer outside the intermediate region.

In the aforementioned embodiments, it may in particular be advantageous for the liquid crystals contained in the intermediate region to be orientated according to the third orientation and/or for the liquid crystals contained in the intermediate region to directly or indirectly cause the amplitude reduction when the maximum electrical voltage or the lower voltage range limit or the upper voltage range limit is applied between the at least one first electrode and one of the second electrodes.

In an advantageous embodiment, the liquid crystals contained in the intermediate region are orientated according to the third orientation.

In particular, it may be advantageous for the liquid crystals contained in the intermediate region to directly or indirectly cause the amplitude reduction when neighboring first electrodes and/or neighboring second electrodes are oppositely poled, in particular oppositely poled with a potential difference of at least 50%, in particular 70%, of the potential difference between an established and/or establishable lower voltage range limit and an established and/or establishable upper voltage range limit. This embodiment takes account of the fact that the problem of the described perturbing effects does not occur, or occurs only to a reduced extent, when there is no electrical potential difference or only a small electrical potential difference between neighboring electrodes. This is, in particular, because there is then no transverse electric field, or at most a transverse electric field to a lesser extent, which—perturbingly in the case of conventional liquid-crystal devices—could unfavorably orientate the liquid crystals in the intermediate region differently than in the central region of the electrodes.

One embodiment, which can be used very versatilely, in particular for holographic displays, is formed in such a way that the amplitude of the light passing through the liquid-crystal layer outside the intermediate region is constant independently of the applied voltage, at least within a defined voltage range, which preferably corresponds to a phase shift of between 0 and 2 pi.

An amplitude reduction of the light passing through the intermediate region of the liquid-crystal device can be achieved, in particular, in an embodiment in which the first and/or second electrodes have a field-influencing electrode structure, in particular a non-homogeneous resistance profile. Such a resistance profile may, for example, be produced by multiple coating of a substrate carrying the electrodes.

It has been found that a particularly advantageous embodiment is one in which the distance between neighboring first electrodes is less than 15 percent, in particular less than 10 percent, more particularly less than 7 percent of the width of one of the neighboring first electrodes and/or the distance between neighboring second electrodes is less than 15 percent, in particular less than 10 percent, more particularly less than 7 percent of the width of one of the neighboring second electrodes.

The liquid-crystal device may advantageously be used as part of a holographic display or of a projection display. A light modulation apparatus for a display for the representation of two- and/or three-dimensional image contents or image sequences, which comprises a liquid-crystal device according to the invention, is particularly advantageous. In particular, the liquid-crystal device according to the invention may advantageously be used in a light modulation apparatus according to the teaching of WO 2010/149587 A2, or be configured in the form of a light modulation apparatus as claimed in one of claims 1 to 36 of WO 2010/149587 A2.

The subject-matter of the invention is schematically represented in the drawing and will be described below with the aid of the figures, elements which are the same or have the same effect being provided with the same references.

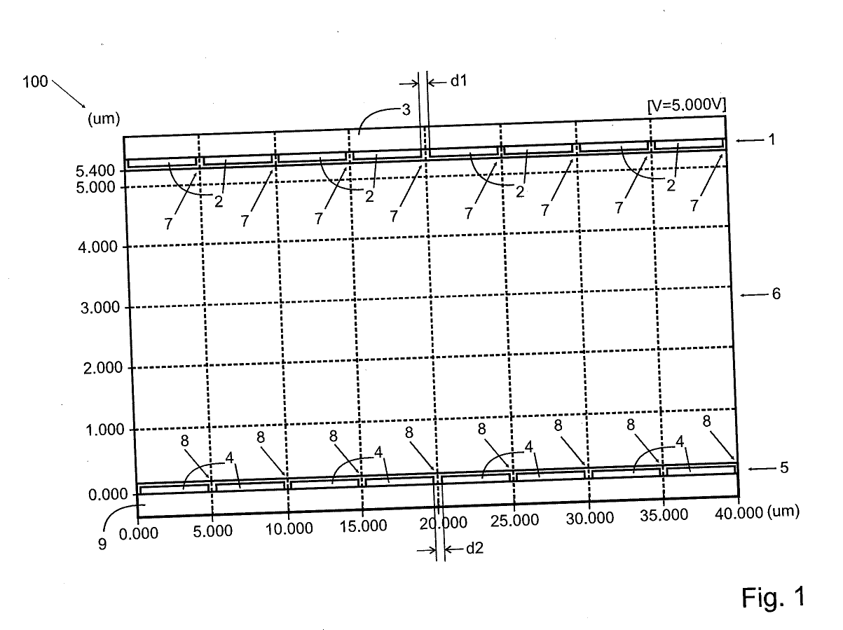

FIG. 1 shows the structure of an exemplary embodiment of a liquid-crystal device according to the invention in a schematic representation in a sectional view,

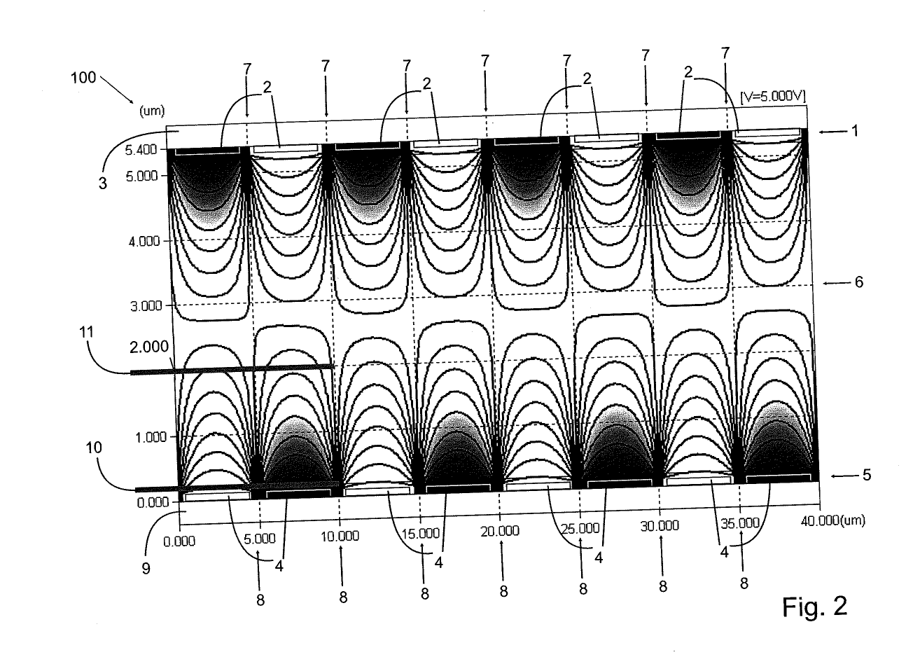

FIG. 2 shows a field distribution prevailing in the exemplary embodiment of FIG. 1 in the case of oppositely poled neighboring electrodes,

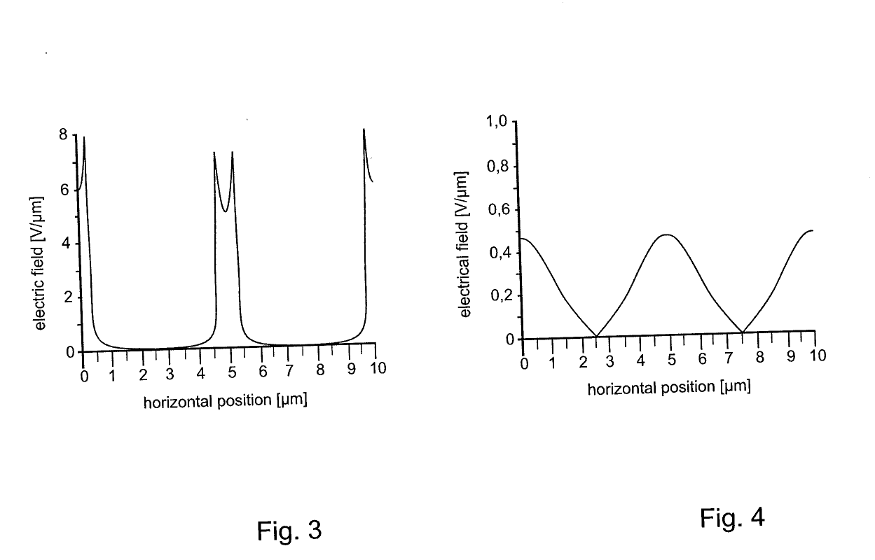

FIG. 3 shows the electric field strength in a diagram as a function of a horizontal position, i.e. parallel to the first or second plane, in the vicinity of the intermediate regions,

FIG. 4 shows the electric field strength in a diagram as a function of a horizontal position away from the intermediate regions and

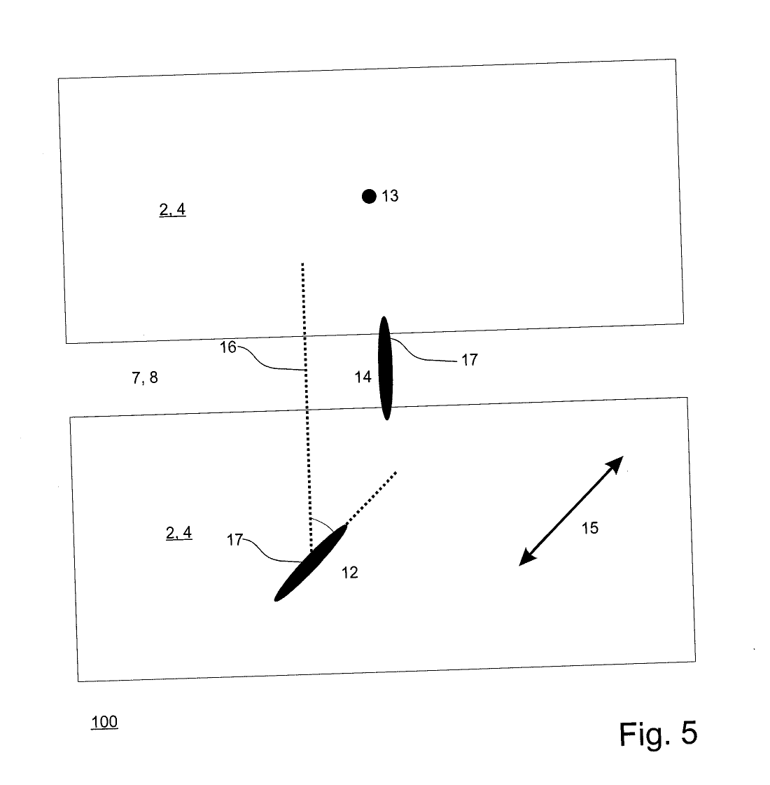

FIG. 5 shows the first, second and third orientations in a schematic representation in a plan view for an exemplary embodiment of a liquid-crystal device according to the invention, which uses an ECB LC mode.

FIG. 1 shows the structure of an exemplary embodiment of a liquid-crystal device 100 according to the invention in a schematic representation in a sectional view.

The liquid-crystal device 100 comprises a plurality of first electrodes 2, which are transparent for the light interacting with the liquid-crystal device 100 and are arranged in a first plane 1. The first electrodes 2 are arranged on a transparent first substrate 3. The liquid-crystal device 100 furthermore comprises a plurality of second electrodes 4, which lie opposite the first electrodes 2, are transparent for the light interacting with the liquid-crystal device 100 and are arranged in a second plane 5, which is essentially parallel to the first plane 1, a liquid-crystal layer 6 being arranged between the first plane 1 and the second plane 5. The second electrodes 4 are arranged on a transparent second substrate 9.

The liquid-crystal layer 6 is formed in order to modify a property, in particular the phase and/or the polarization, of light passing through the liquid-crystal layer 6, as a function of the level of an electrical voltage applied between opposing first electrodes 2 and second electrodes 4.

The first electrodes 2 are formed and arranged in such a way that a transverse electric field can respectively be generated in first intermediate regions 7 between neighboring first electrodes 2, which orientates the liquid crystals contained in respectively a first intermediate region 7 in such a way, particularly in cooperation with further components (not shown) of the liquid-crystal device 100, for example one or more polarization filters (not shown), as to cause, directly or indirectly, an amplitude reduction of light passing through the intermediate region 7 of the liquid-crystal device 100, which is greater than an amplitude reduction of the light passing through the liquid-crystal layer 6 outside the intermediate region 7.

The second electrodes 4 are also formed and arranged in such a way that in each case a transverse electric field can be generated in second intermediate regions 8 between neighboring second electrodes 4, which orientates the liquid crystals contained in respectively a second intermediate region 8 in such a way, particularly in cooperation with further components (not shown) of the liquid-crystal device 100, for example one or more polarization filters (not shown), as to cause, directly or indirectly, an amplitude reduction of light passing through the intermediate region 8 of the liquid-crystal device 100, which is greater than an amplitude reduction of the light passing through the liquid-crystal layer 6 outside the intermediate region 8.

Specifically, the distance dl between neighboring first electrodes 2 and the distance d2 between neighboring second electrodes 4 is small enough that, in the intermediate regions 7, 8, it is possible to generate a respective transverse electric field which orientates the liquid crystals contained in the intermediate region 7, 8 in such a way, as to cause, directly or indirectly, an [symbol] region 7, 8 of the liquid-crystal device 100, which is greater than an amplitude reduction of the light passing through the liquid-crystal layer 6 outside the intermediate region 7, 8.

In the embodiment shown, the distance d1 between neighboring first electrodes 2 and the distance d2 between neighboring second electrodes 4 is about 0.6 micrometer, while the width of the electrodes 2, 4 is about 4.4 micrometers. In this example, the distance d1 between neighboring first electrodes 2 and the distance d2 between neighboring second electrodes 4 are thus less than 15 percent (to be precise 13.6 percent) of the width of the electrodes 2, 4.

A voltage range of from 0 volt to 5 volts is defined, in which a lower voltage range limit of 0 volt is assigned to a minimum phase retardation of the light passing through the liquid-crystal layer 6 outside the intermediate region 7, 8, and in which an upper voltage range limit of 5 volts is assigned to a maximum phase retardation of the light passing through the liquid-crystal layer 6 outside the intermediate region 7, 8. In the liquid-crystal device 100 represented, the liquid crystals contained in the intermediate regions 7, 8 directly or indirectly cause the amplitude reduction when neighboring first electrodes 2 or neighboring second electrodes 4 are oppositely poled.

The field distribution in the case in which the neighboring first electrodes 2 and the neighboring second electrodes 4 are respectively oppositely poled with a potential difference of 5 volts is represented in the form of equipotential lines in FIG. 2.

In FIG. 2, it can be seen that the field line density in the intermediate regions 7, 8 is very high, and in fact so high that the liquid crystals contained therein are orientated differently than the other liquid crystals.

FIG. 3 shows the electric field strength as a function of the position along a line parallel to the second plane 5. The line is denoted by the reference 10 in FIG. 2, and lies in the immediate vicinity of the plane 5. It can be seen clearly that, in particular owing to the short distance d2 between the electrodes 4, particularly high field strengths are achieved in the intermediate regions 8, which cause the special orientation of the liquid crystals in the intermediate regions 8.

FIG. 4 shows the electric field strength as a function of the position along a different line parallel to the second plane 5. This different line is denoted by the reference 11 in FIG. 2 and lies at a position separated from the plane 5. It can be seen clearly that substantially lower field strengths prevail outside the intermediate regions 7, 8, namely field strengths such as are necessary in order to cause orientations of the liquid crystals which are necessary in order to achieve phase retardations of from 0 to 2 pi of the light passing through the liquid-crystal layer 6. and which are different from the third orientation of the liquid crystals in the intermediate regions 7, 8.

FIG. 5 shows the first, second and third orientations 12, 13 and 14 in a schematic representation in a plan view for an exemplary embodiment of a liquid-crystal device 100 according to the invention, which uses an ECB LC mode.

In this view, the first and second planes, comprising the electrodes 2, 4, and the intermediate spaces 7, 8 lie on one another, respectively parallel to the plane of the drawing.

A first orientation 12 of the LC molecules is shown, which is parallel to these planes and rotated through 45 degrees relative to the connecting line 16, represented by dots, between two first electrodes 2, or between two second electrodes 4. To represent the LC molecules, only one LC molecule 17 is shown schematically as an elongate ellipsoid. This orientation can be generated by surface orientation on the substrate (for example by a surface alignment layer) or on the electrodes 2, 4. Also shown schematically is the second orientation 30, which is generated by an electric field between a first electrode 2 and an opposing second electrode 4. In this case, the longitudinal axis of the LC molecules 17 points out of the plane of the drawing. In the intermediate region 7, 8, according to the invention a third orientation 14 is generated by a transverse field between two first electrodes 2, or between two second electrodes 4. In this case, the LC molecules 17 are orientated parallel to the plane of the drawing and parallel to the connecting line 16 between the two electrodes 2, or between the two electrodes 4.

In FIG. 5, the transmission direction for a linear polarizer (not shown in FIG. 5) is furthermore indicated schematically by the arrow 15. In this exemplary embodiment, there is respectively a linear polarizer on the input side and on the output side of the substrates (not shown in FIG. 5), the transmission directions of which are mutually parallel and parallel to the first orientation 12 of the LC molecules 17.

The invention has been described with reference to particular embodiments. It is, however, clear that modifications and variants may be made without thereby departing from the protective scope of the appended claims.

1. A liquid-crystal device, comprising:
at least one first electrode arranged in a first plane;
a plurality of second electrodes arranged in a second plane essentially parallel to the first plane;
a liquid-crystal layer arranged between the first plane and the second plane, which liquid-crystal layer is formed to modify a property, of light passing through the liquid-crystal layer as a function of a level of an electrical voltage applied between the at least one first electrode and at least one of the plurality of second electrodes, wherein:
the plurality of second electrodes are formed and arranged in such that a transverse electric field can be generated in an intermediate region between neighboring second electrodes, thereby orienting liquid crystals contained in the intermediate region, of the liquid-crystal device, to cause an amplitude reduction of light passing through the intermediate region of the liquid-crystal device, which amplitude reduction is greater than an amplitude reduction of light passing through the liquid-crystal layer outside the intermediate region.

2. The liquid-crystal device as claimed in claim 1, wherein the distance between neighboring second electrodes is small enough that, in the intermediate region, it is possible to generate a transverse electric field which orientates the liquid crystals contained in the intermediate region in such a way, as to cause, directly or indirectly, an amplitude reduction of light passing through the intermediate region of the liquid-crystal device, which is greater than an amplitude reduction of the light passing through the liquid-crystal layer outside the intermediate region.

3. The liquid-crystal device as claimed in claim 1, wherein a plurality of first electrodes are arranged in the first plane.

4. The liquid-crystal device as claimed in claim 3, wherein the first electrodes are formed and arranged in such a way that, in an intermediate region between neighboring first electrodes, it is possible to generate a transverse electric field which orientates the liquid crystals contained in the intermediate region in such a way, particularly in cooperation with further components of the liquid-crystal device, for example one or more polarization filters, as to cause, directly or indirectly, an amplitude reduction of light passing through the intermediate region of the liquid-crystal device, which is greater than an amplitude reduction of the light passing through the liquid-crystal layer outside the intermediate region.

5. The liquid-crystal device as claimed in claim 1, wherein, as a function of the level of an electrical voltage applied between the at least one first electrode and the second electrodes, liquid crystals of the liquid-crystal layer can be orientated in a first orientation or in a second orientation, in particular perpendicular to the first, or in intermediate settings between the first orientation and the second orientation.

6. The liquid-crystal device as claimed in claim 5, wherein, in the intermediate region between a plurality of neighboring first electrodes and/or in the intermediate region between neighboring second electrodes, it is possible to generate a transverse electric field which leads to a third orientation, different than the first orientation and the second orientation and intermediate settings between the first orientation and the second orientation, of the liquid crystals contained in the intermediate region.

7. The liquid-crystal device as claimed in claim 5, wherein the direction of the first orientation and the direction of the second orientation are arranged in the same plane as the directions of the intermediate settings.

8. The liquid-crystal device as claimed in claim 6, wherein the direction of the third orientation is orientated perpendicularly to the first orientation or perpendicularly to the second orientation or perpendicularly to the direction of at least one of the intermediate settings.

9. The liquid-crystal device as claimed in claim 5, wherein the direction of the first orientation or the direction of the second orientation are respectively arranged parallel to the first and second planes, while the direction of the third orientation is arranged at a non-zero degree angle, in particular perpendicularly, to the first or second plane.

10. The liquid-crystal device as claimed in claim 5, wherein the direction of the third orientation is arranged parallel to the first and second planes.

11. The liquid-crystal device as claimed in claim 1, wherein
a. a maximum electrical voltage is defined, at which the liquid crystals arranged outside the intermediate region are orientated either in the first or in the second orientation or at which, in relation to light which passes through the liquid-crystal layer outside the intermediate region, a relative phase retardation of 2 pi can be induced between the first and second orientation, or wherein
b. a voltage range is defined, in which a lower voltage range limit is assigned to a minimum phase retardation of the light passing through the liquid-crystal layer outside the intermediate region and in which an upper voltage range limit is assigned to a maximum phase retardation of the light passing through the liquid-crystal layer outside the intermediate region, or, vice versa, in which a lower voltage range limit is assigned to a maximum phase retardation of the light passing through the liquid-crystal layer outside the intermediate region and in which an upper voltage range limit is assigned to a minimum phase retardation of the light passing through the liquid-crystal layer outside the intermediate region,

12. The liquid-crystal device as claimed in claim 11, wherein the liquid crystals contained in the intermediate region are orientated according to the third orientation or wherein the liquid crystals contained in the intermediate region directly or indirectly cause the amplitude reduction when the maximum electrical voltage or the lower voltage range limit or the upper voltage range limit is applied between the at least one first electrode and one of the second electrodes.

13. The liquid-crystal device as claimed in claim 1, wherein the liquid crystals contained in the intermediate region are orientated according to the third orientation or wherein the liquid crystals contained in the intermediate region directly or indirectly cause the amplitude reduction when neighboring first electrodes and/or neighboring second electrodes are oppositely poled.

14. The liquid-crystal device as claimed in claim 1, wherein the amplitude of the light passing through the liquid-crystal layer outside the intermediate region is constant independently of the applied voltage, at least within a defined voltage range, which preferably corresponds to a phase shift of between 0 and 2 pi.

15. The liquid-crystal device as claimed in claim 1, wherein the first and/or second electrodes have a field-influencing electrode structure, in particular a non-homogeneous resistance profile, or wherein the first and/or second electrodes have a field-influencing electrode structure in the form of a non-homogeneous resistance profile, the non-homogeneous resistance profile being produced by multiple coating.

16. The liquid-crystal device as claimed in claim 1, wherein the distance between neighboring first electrodes is less than 15 percent, in particular less than 10 percent, more particularly less than 7 percent of the width of one of the neighboring first electrodes or wherein that the distance between neighboring second electrodes is less than 15 percent, in particular less than 10 percent, more particularly less than 7 percent of the width of one of the neighboring second electrodes.

17. The liquid-crystal device as claimed in claim 1, wherein the liquid-crystal device is configured as a light modulation apparatus for the presentation of two- and/or three-dimensional image contents, comprising:
a light modulator (SLM) and a control unit, wherein a phase and/or amplitude of a substantially collimated light wave field is alterable by the light modulator in dependence on the location on the light modulator, said light modulator being controllable by the control unit,
wherein the light modulator is followed by at least one controllable diffraction device in a direction of propagation of a light wave field, said at least one controllable diffraction device comprises a variable diffractive structure and wherein the light wave field having passed the light modulator is variably diffractable by this diffractive structure in a presettable way.

18. A holographic display or projection display or a light modulation apparatus for a display for the representation of two- or three-dimensional image contents or image sequences, which comprises at least one liquid-crystal device as claimed in claim 1.

19. The liquid crystal device as claimed in claim 1, wherein the property of light to modify is the phase and/or the polarization or wherein the amplitude reduction of light is caused by orienting the liquid crystals in cooperation with one or more polarization filters.
